(19) United States
(12) Patent Application Publication
(10) Pub. No.: US 2025/0078438 A1
(43) Pub. Date: Mar. 6, 2025

(54) APPARATUS AND METHOD FOR OBJECT DETECTION

(71) Applicant: Robert Bosch GmbH, Stuttgart (DE)

(72) Inventors: Felicia Ruppel, Renningen (DE); Mathijs Van Geerenstein, Stuttgart (DE)

(21) Appl. No.: 18/809,424

(22) Filed: Aug. 20, 2024

(30) Foreign Application Priority Data
Aug. 29, 2023 (DE) 10 2023 208 267.5

(51) Int. Cl. G06V 10/25; G01S 17/86; G06T 7/70; G06V 10/44; G06V 10/764; G06V 10/80

(52) U.S. Cl. CPC G06V 10/25; G01S 17/86; G06T 7/70; G06V 10/44; G06V 10/764; G06V 10/806; G06V 2201/07

(57) ABSTRACT

Object detection using multi-modal sensor input. The method includes: detecting first sensor data in an image section using a first sensor device and forming corresponding first feature vectors; detecting second sensor data in the image section using a second sensor device and forming corresponding second feature vectors; providing an arrangement including a grid with a predetermined first plurality of proposed locations for object search; extracting feature vectors from the first and second feature vectors, respective merging of first with second feature vectors at the proposed locations; generating a respective estimated bounding box for each of the proposed locations in the environment of the proposed locations, and calculating a respective confidence level each bounding box; reducing the first plurality of proposed locations to a second number of locations, based on the respective calculated confidence levels; and recognizing an object based on an object search at the second number of locations.

### CROSS REFERENCE

The present application claims the benefit under 35 U.S.C. § 119 of German Patent Application No. DE 10 2023 208 267.5 filed on Aug. 29, 2023, which is expressly incorporated herein by reference.

### FIELD

The present invention relates to an apparatus and to a method for object detection.

### BACKGROUND INFORMATION

Object detection is a subfield of computer-based vision, where one tries to identify individual objects in sensor data. In so doing, the sensor data are divided into regions that form meaningful units that are then further examined for features in order to assign the image region to a class of objects. With object detection, for example, an image is divided into smaller image sections (windows) of a certain size, and then a classification algorithm is applied to these windows.

Such reliable object detection is respectively relevant in the field of autonomous driving of motor vehicles, wherein the representation of the environment of the motor vehicle is detected by means of sensor devices, e.g., camera, LIDAR, RADAR, etc.

In recent years, the transformer architecture has been initially developed for the field of speech processing and then also lly applied to two-dimensional and three-dimensional object detection. Transformer-based object detectors are founded on so-called object queries, i.e. high-dimensional vectors, wherein each of them can be understood as an object candidate that can detect at most one object.

An object query (also called object search) is substantially a feature vector in a latent space or embedding space that encodes the information that is necessary to predict a classified two-dimensional or three-dimensional bounding box.

Typically, each object query is associated with a reference point or anchor point relative to which the bounding box is predicted. The initialization of these object queries is currently being intensively researched. A distinction is made between two basic approaches, namely learning a fixed distribution for the feature vectors by training or initialization based on current sensor inputs.

Object detection with initialization by a learned distribution requires many object queries to cover the entire object detection grid and can miss objects when many objects are arranged in a small space if the object queries cannot cover all objects.

Object detection with initialization based on current sensor inputs solves this problem by placing the object queries at locations where objects are expected according to predictions from a previous stage using a trainable network.

X. Bai et al. in “TransFusion: Robust LiDAR-Camera Fusion for 3D Object Detection with Transformers,” Proceedings of the IEEE Computer Society Conference on Computer Vision and Pattern Recognition, June 2022 pp. 1080-1089 describe object detection with initialization based on current sensor inputs from LIDAR and from a camera, wherein camera-based features are used to refine predictions of an initial set of LIDAR data. However, this method does not make optimal use of the sensor inputs from the camera, since the feature vectors for the object query are initialized with the sensor inputs from the LIDAR, and the sensor inputs from the camera are only used sequentially for refinement.

German Patent Application No. DE 10 2009 006 113 A1 describes an apparatus and a method for providing a representation of the environment of a vehicle with at least one first sensor device and at least one second sensor device as well as an evaluation device, wherein the sensor devices provide information about objects recognized in an environment of the vehicle in the form of sensor objects, wherein a sensor object represents an object recognized by the respective sensor device, and the sensor objects comprise, as an attribute, at least one probability of existence of the represented object and the sensor objects recognized by the at least one first sensor device and by the at least one second sensor device (3) are subjected to an object merging in which merging objects are generated to which at least one probability of existence is assigned as an attribute, wherein the probabilities of existence of the merging objects are merged based on the probabilities of existence of the sensor objects, wherein the merging of the probability of existence of one of the sensor objects is carried out in each case depending on the respective sensor device from which the corresponding sensor object is provided.

German Patent Application No. DE 11 2018 000 899 T5 describes a method for identifying objects from a 3D point cloud and a 2D image, comprising the steps of: determining a first set of 3D proposals using Euclidean clustering on the 3D point cloud, determining a second set of 3D proposals from the 3D point cloud based on a 3D convolutional neural network, merging the first set of 3D proposals and the second set of 3D proposals to determine a set of 3D candidates, projecting the first set of 3D proposals onto the 2D image, determining a first set of 2D proposals based on the image using a 2D convolutional neural network, merging the projected first set of 3D proposals and the first set of 2D proposals to determine a set of 2D candidates, and merging the set of 3D candidates and the set of 2D candidates.

German Patent Application No. DE 10 2019 127 282 A1 describes a system for analyzing a three-dimensional environment, comprising: a sensor unit that is configured to provide a point cloud that represents the three-dimensional environment, an RGB camera sensor for providing at least one RGB image with RGB color information of the three-dimensional environment, a first processing unit for fusing the point cloud from the sensor unit with the RGB color information from the RGB image of the RGB camera sensor into an RGB point cloud, a second processing unit for performing at least one of the following tasks: the task of object detection, the task of semantic segmentation, or the task of classification with respect to the three-dimensional environment, wherein the first processing unit is configured to provide the second processing unit with the merged RGB point cloud, the second processing unit comprises an encoder, a first decoder for the object task of detection, a second decoder for the task of semantic segmentation and a third decoder for the task of classification, wherein the encoder is configured to receive the point cloud as input data, to extract features that are required to perform the tasks of object detection, semantic segmentation and classification from the input data based on a deep neural network, and feeding the extracted features to the first decoder, the second decoder and the third decoder, and wherein the first decoder, the second decoder and the third decoder in each case have a neural network that is dedicated to its respective task.

### SUMMARY

Presented are an apparatus for object detection, in particular using multi-modal sensor input, and a method for object detection, in particular using multi-modal sensor input.

According to an example embodiment of the present invention, the initial estimation of object features can first be carried out for a large number of initial object queries in a defined arrangement, e.g., a grid, by connecting the sensor inputs from a first sensor device, e.g., from LIDAR, and from a second sensor device, e.g., from a camera. Subsequently, a reduction of the number of object queries can be carried out, and their placement can be undertaken based on a statistical evaluation of the formed merged feature correlations. This enables a drastic reduction of the initialization overhead by typically 90% compared to the state of the art (TransFusion). The first and the second sensor device can belong to different sensor types (e.g., camera-LIDAR, LIDAR-RADAR, RADAR, camera), so-called multi-modal sensor input, or be different sensors of the same sensor type (e.g., camera-camera, LIDAR-LIDAR, RADAR-RADAR). The first and second sensor devices are to be understood as a minimum quantity. The described apparatuses and methods can also be used correspondingly enhanced with additional sensor devices (multi-modal or not). In an alternative embodiment, the method for reducing the location for object queries is possible for a system with one sensor.

According to a preferred development of the present invention, an output device is designed to output an object detection representation based on the object search result.

According to a further preferred development of the present invention, the first sensor device comprises a LIDAR sensor device, and the second sensor device comprises a camera sensor device.

According to a further preferred development of the present invention, the grid can be spanned two-dimensionally in a plane, and each proposed location for an object search can be assigned an equal fixed height in order to make the grid three-dimensional.

According to a further preferred development of the present invention, the decoder is a transformer decoder that has a regression head and a classification head.

According to a further preferred development of the present invention, the respective predicted features for the object search are predictable using the regression head and the classification head.

According to a further preferred development of the present invention, the initial position on the grid of an object query can be displaced by a respective predicted or estimated offset, with the aim of moving closer to an object.

The present invention is explained in more detail below based upon the exemplary embodiments indicated in the schematic figures.

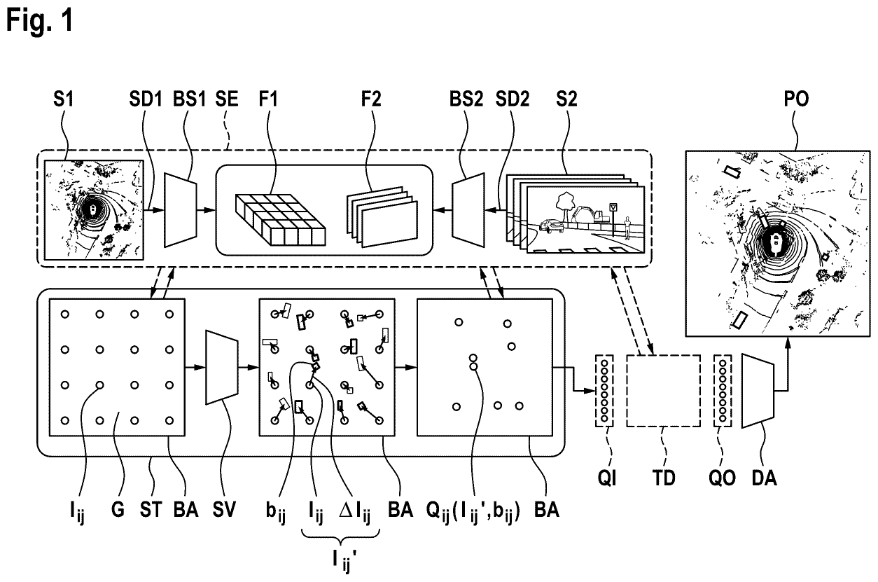

FIG. 1 shows a schematic block diagram for explaining an apparatus for object detection using multi-modal sensor input according to a first example embodiment of the present invention.

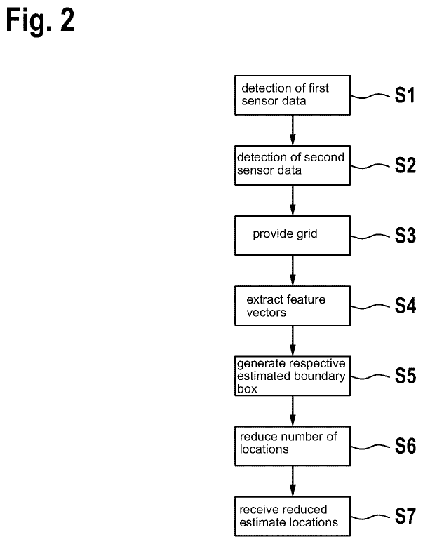

FIG. 2 shows a schematic flow chart for explaining a method for object detection using multi-modal sensor input according to a second example embodiment of the present invention.

### DETAILED DESCRIPTION OF EXAMPLE EMBODIMENTS

The figures are intended to impart further understanding of the embodiments of the present invention. They illustrate embodiments and, in connection with the description, serve to explain principles and concepts of the present invention. Other embodiments and many of the mentioned advantages are apparent from the drawings. The elements of the drawings are not necessarily shown to scale relative to one another.

In the figures, identical, functionally identical and identically acting elements, features and components are provided with the same reference signs in each case, unless otherwise stated.

FIG. 1 shows a schematic block diagram for explaining an apparatus for object detection using multi-modal sensor input according to a first embodiment of the present invention.

The apparatus for object detection using multi-modal sensor input in an environment of a carrier device, in particular a motor vehicle, according to the first embodiment has a sensor part SE, a processing part ST, a transformer decoder TD and an output device DA.

Although they can be designed differently, in the present embodiment these components or parts are arranged on a common carrier device, e.g., a motor vehicle.

The sensor part SE includes a first sensor device S1, BS1 comprises a LIDAR sensor device for detecting first sensor data SD1 in an image section BA of the environment and further comprises a first converter device BS1 for forming corresponding first feature vectors F1 from the first sensor data SD1. Alternatively, the first feature vectors F1 can also be formed in the processing part ST.

The sensor part SE also includes a second sensor device S2, BS2 comprises a camera sensor device S2 for detecting second sensor data SD2 in the image section BA of the environment and further comprises a second converter device BS2 for forming corresponding second feature vectors (M2) from the second sensor data SD2. Alternatively, the second feature vectors F2 can also be formed in the processing part ST.

The processing part ST includes a processing device, e.g., a computer. The processing device ST uses outputs of the first sensor device S1, BS1 and the second sensor device S2, BS2 to provide proposed locations l′ᵢⱼ for object search.

For this purpose, the processing device ST provides an arrangement such as in particular a grid G with a first, in particular predetermined, plurality of proposed locations lᵢⱼ for object search in the image section BA, which can cover the image section BA, for example, substantially homogeneously, but can also have deviating distributions. Typically, the number of grid points lᵢⱼ is approximately 3000 to 5000.

For example, a grid G is generated in such a way that the grid G is spanned two-dimensionally in an x, y plane (bird's eye view) over the image section BA, and each proposed location lᵢⱼ for object search is assigned an equal fixed height in order to make the grid (G) three-dimensional and therefore establish the first plurality of proposed locations lᵢⱼ for object search in the image section BA.

The processing device calculates a projection to determine which regions of the feature arrangement F1, F2 are closest to the proposed locations lᵢⱼ. For the camera sensor data S2, this means a projection of the proposed locations lᵢⱼ into the image space. Based on the projection, feature vectors F1′, F2′ in the environment of the proposed locations lᵢⱼ for object search are extracted from F1, F2 and merged, for example by concatenation.

The processing device ST is further designed to generate a respective predicted bounding box bᵢⱼ for the object search in the environment of the proposed locations lᵢⱼ for the object search. A location of the bounding boxes bᵢⱼ can be determined, for example, by their respective geometric center. The object features bᵢⱼ and a confidence level are determined by the regression and classification head SV.

For example, the decoder TD is for example a trained transformer decoder that has a regression head and a classification head associated therewith, and the respective predicted bounding boxes bᵢⱼ for object search are predicted using the regression head and the classification head.

The processing device ST then reduces predicted bounding box bᵢⱼ for the object search to a predetermined second plurality, which is substantially smaller than the first plurality, based on a respective confidence level determined from the associated merged feature vectors that are obtained by a detection head SV.

Typically, the number of reduced predicted bounding boxes bᵢⱼ is approximately 200-900.

Optionally, the center of each predicted bounding box bᵢⱼ for object search is determined by offsetting the initial proposed location lᵢⱼ by a respective predicted or estimated offset Δᵢⱼ to an offset proposed location lᵢⱼ′ for object search using the regression head (SV). Then, new merged feature vectors in the environment of the offset proposed locations lᵢⱼ for object search are determined from the associated first and second feature vectors F1, F2.

The trained transformer decoder TD receives the corresponding optionally offset reduced locations lᵢⱼ or lᵢⱼ′ as initial locations for object queries, as well as optionally the associated bounding boxes bᵢⱼ and outputs a corresponding object search result QO.

An output device DA serves to output an object detection representation PO) based on the object search result QO, for example on a screen. Further internal processing, for example to activate an actuator without the output device DA, is also possible.

FIG. 2 is a schematic flow chart for explaining a method for object detection using multi-modal sensor input according to a second embodiment of the present invention.

In step S1, a detection of first sensor data SD1 is carried out in an image section BA by means of a first sensor device S1, BS1, and corresponding first feature vectors F1 are formed.

In step S2, a detection of second sensor data SD2 is carried out in the image section BA by means of a second sensor device S2, BS2, and corresponding second feature vectors M2 are formed.

Image section BA can in each case only represent a part of the detection ranges of the first and second sensor device in which the two detection ranges overlap.

In step S3, a provision of an arrangement, e.g., a grid G, with a predetermined first plurality of proposed locations lᵢⱼ for object search in the image section BA is carried out. In one embodiment, the arrangement covers the image section BA substantially homogeneously, but different patterns of the arrangement of the proposed locations are also possible, e.g., with a focus (i.e., smaller distance between the locations) in the center of the image.

In step S4, an extraction of feature vectors F1′, F2′ is carried out from the first and second feature vectors F1, F2 in the environment of the proposed locations lᵢⱼ for object search, and respective merging of the corresponding feature vectors at a specific one of the proposed locations Iᵢⱼ, in particular by concatenation.

In step S5, a generation of a respective estimated bounding box bᵢⱼ and a confidence level for the object search in the environment of the proposed locations lᵢⱼ for the object search is carried out from the associated merged feature vectors F1′, F2′. The confidence level represents a value for the confidence of the bounding boxes (e.g., their location and size). It can be determined with the utilized trained model or network. The formation of bounding boxes and confidence levels is preferably carried out as described with regard to FIG. 1.

In step S6, for the further object search, a reduction of the number of locations is carried out starting from the originally proposed locations to a predetermined second plurality that is smaller, in particular significantly smaller, than the first plurality, based on the respective confidence levels for the bounding boxes determined from the associated merged feature vectors F1, F2. The locations can be determined from the bounding boxes with the highest confidence levels, in particular in that the locations correspond to the centers of the bounding boxes with the highest confidence levels. The latter step not only correspondingly reduces the locations in number, but also shifts them spatially depending on the position of the bounding boxes.

In step S7, a reception of the reduced estimated locations l′ᵢⱼ is carried out as initial locations for object queries object search QI, and in particular a corresponding object search result QO is output by means of a trained decoder TD and regression head/classification head DA.

Although the present invention has been described with reference to preferred embodiments, it is not limited thereto, but can be modified in many ways.

In a particular alternative embodiment, a corresponding method can also be carried out in the case of only one sensor source. In this case, for object recognition, sensor data can be detected in an image section using a sensor device, and corresponding feature vectors can be formed. In each case in the environment of the plurality of proposed locations, a feature vector can be taken from the formed feature vectors. Depending on the extracted feature vectors, respective estimated bounding boxes are calculated for each of the proposed locations in the environment of the proposed locations, and a respective confidence level is formed for the estimated bounding boxes. Based on the respective calculated confidence levels, a reduction of the plurality of proposed locations can be carried out to a number of locations that is smaller than the plurality of proposed locations. By an object search the second number of locations, a recognition of an object can then be carried out.

In particular, the present invention is not limited to a LIDAR sensor device in combination with a camera sensor device, but is applicable to any sensor combinations. A possible merging of the sensor data can be designed in different ways.

The number of the initial first plurality of proposed locations lᵢⱼ for the object search can be designed in any way oriented around the application, as well as the second plurality of reduced proposed shifted locations l′ᵢⱼ, as well as the dimensionality of the feature vectors.

Finally, the present invention is not limited to a transformer decoder, but is applicable to any object detector.

The first plurality of proposed locations lᵢⱼ for the object search can be determined using a three-dimensional grid, or any three-dimensional or two-dimensional arrangement.

The use of the present invention can be lie within the automotive sector, e.g., in driver assistance systems or automated driving functions, but also in robotics or security technology, or other sectors in which object detection is relevant.

What is claimed is:

1. An apparatus for object detection using multi-modal sensor input in an environment of a carrier device, comprising:
a first sensor device configured to detect first sensor data in an image section of the environment;
a second sensor device configured to detect second sensor data in the image section of the environment; and
a processing device configured to provide an arrangement with a predetermined first plurality of proposed locations for object search in the image section;
wherein the processing device is configured to extract feature vectors from first feature vectors that were formed from the first sensor data and second feature vectors that were formed from the second sensor data in an environment of the proposed locations for object search, and is configured to merge the first and the second feature vectors;
wherein the processing device is configured to generate a respective predicted bounding box for the object search in the environment of the proposed locations for the object search, and to generate a confidence level for the respective bounding boxes;
wherein the processing device is configured to reduce the first plurality of proposed locations for the object search to a second number of estimated locations that is smaller than the first plurality, based on the respective confidence level determined from the merged feature vectors; and
wherein the processing device is configured to perform the object search at the estimated locations and to output resulting object search results.

2. The apparatus according to claim 1, wherein the carrier device is a motor vehicle.

3. The apparatus according to claim 1, further comprising:
an output device configured to output an object detection representation based on the object search results.

4. The apparatus according to claim 1, wherein the first sensor device and the second sensor device each include one of: a LIDAR device, a RADAR device or a camera sensor device.

5. The apparatus according to claim 1, wherein the first sensor device and the second sensor device represent two different LIDAR devices, or RADAR devices, or camera sensor devices.

6. The apparatus according to claim 1, wherein the arrangement is a grid that can be spanned two-dimensionally in a plane and an equal fixed height can be assigned to each of the proposed locations for the object search in order to make the grid three-dimensional.

7. The apparatus according to claim 1, wherein the arrangement for the object search accesses a decoder that is a transformer decoder that has a regression head and a classification head.

8. The apparatus according to claim 7, wherein the predicted bounding boxes for the object search are predictable using the regression head.

9. The apparatus according to claim 7, wherein each of the predicted bounding boxes for the object search is displaceable by a respective predicted offset from a corresponding proposed location for the object search using the regression head.

10. A method for object detection, in particular using multi-modal sensor input, the method comprising the following steps:
detecting first sensor data in an image section using a first sensor device, and forming corresponding first feature vectors;
detecting second sensor data in the image section using a second sensor device, and forming corresponding second feature vectors;
providing an arrangement with a predetermined first plurality of proposed locations for object search in the image section;
extracting feature vectors from the first and second feature vectors in an environment of the proposed locations, and respective merging of first and second feature vectors at the proposed locations;
generating a respective estimated bounding box for each of the proposed locations in the environment of the proposed locations depending on the merged first and second feature vectors, and calculating a respective confidence level for each of the bounding boxes;
reducing the first plurality of proposed locations to a second number of locations that is smaller than the first plurality, based on the respective calculated confidence levels; and
recognizing an object based on an object search at the second number of locations.

11. The method according to claim 10, further comprising outputting an object detection representation based on an object search result.

12. The method according to claim 10, wherein each of the first sensor device and the second sensor device is a LIDAR device, or a RADAR device, or a camera sensor devices.

13. The method according to claim 10, wherein the first sensor device and the second sensor device are two different LIDAR devices or RADAR device or camera sensor devices.

14. The method according to claim 10, wherein the arrangement is a grid that is spanned two-dimensionally in a plane, and each proposed location for object search is assigned an equal fixed height in order to make the grid three-dimensional.

15. The method according to claim 10, wherein the object search is carried out using a trained decoder that is a transformer decoder that has a regression head and a classification head.

16. The method according to claim 15, wherein the respective predicted bounding boxes for the object search are predicted using the regression head.

17. The method according to claim 15, wherein positions for corresponding ones of the second number of locations are determined from the bounding boxes from the environment of the first plurality of proposed locations.

18. A method for object detection, comprising the following steps:
detecting sensor data in an image section using a sensor device and forming corresponding feature vectors;
extracting feature vectors from the formed feature vectors in an environment of a plurality of proposed locations;
generating a respective estimated bounding box for each of the proposed locations in the environment of the proposed locations depending on the extracted feature vectors, and calculating a respective confidence level for each of the estimated bounding boxes;
reducing the plurality of proposed locations to a number of locations that is smaller than the plurality of proposed locations, based on the respective calculated confidence levels; and
recognizing an object based on an object search at the second number of locations.
